(19) United States
(12) Patent Application Publication
(10) Pub. No.: US 2025/0386197 A1
(43) Pub. Date: Dec. 18, 2025

(54) PROTECTION SCHEME CONFIGURATION IN COMMUNICATION NETWORK ENVIRONMENT

(71) Applicant: Nokia Technologies Oy, Espoo (FI)

(72) Inventors: Ranganathan MAVUREDDI DHANASEKARAN, Munich (DE); Saurabh KHARE, Bangalore (IN); Sung Hwan WON, Dallas, TX (US)

(21) Appl. No.: 18/878,202

(22) PCT Filed: Jun. 21, 2023
(86) PCT No.: PCT/IB2023/056429

§ 371 Date: Dec. 23, 2024

Related U.S. Application Data
(60) Provisional application No. 63/354,460, filed on Jun. 22, 2022.

(51) Int. Cl. H04W 12/30; H04W 8/22; H04W 12/06; H04W 12/75

(52) U.S. Cl. CPC H04W 12/35; H04W 8/22; H04W 12/06; H04W 12/75

(57) ABSTRACT

Techniques for protection scheme configuration in a communication network are disclosed. For example, a home communication network of given user equipment sends protection scheme configuration data to the given user equipment using a user equipment parameter update procedure, or a steering of roaming procedure in a visited communication network scenario.

### FIELD

The field relates generally to communication networks, and more particularly, but not exclusively, to security management in such communication networks.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

Fourth generation (4G) wireless mobile telecommunications technology, also known as Long Term Evolution (LTE) technology, was designed to provide high capacity mobile multimedia with high data rates particularly for human interaction. Next generation or fifth generation (5G) technology is intended to be used not only for human interaction, but also for machine type communications in so-called Internet of Things (IoT) networks.

While 5G networks are intended to enable massive IoT services (e.g., very large numbers of limited capacity devices) and mission-critical IoT services (e.g., requiring high reliability), improvements over legacy mobile communication services are supported in the form of enhanced mobile broadband (eMBB) services providing improved wireless Internet access for mobile devices.

In an example communication system, user equipment (5G UE in a 5G network or, more broadly, a UE) such as a mobile terminal (subscriber) communicates over an air interface with a base station or access point of an access network referred to as a 5G AN in a 5G network. The access point (e.g., gNB) is illustratively part of an access network of the communication system. For example, in a 5G network, the access network referred to as a 5G AN is described in 5G Technical Specification (TS) 23.501, entitled “Technical Specification Group Services and System Aspects; System Architecture for the 5G System,” and TS 23.502, entitled “Technical Specification Group Services and System Aspects; Procedures for the 5G System (5GS),” the disclosures of which are incorporated by reference herein in their entireties. In general, the access point (e.g., gNB) provides access for the UE to a core network (CN or 5GC), which then provides access for the UE to other UEs and/or a data network such as a packet data network (e.g., Internet).

TS 23.501 goes on to define a 5G Service-Based Architecture (SBA) which models services as network functions (NFs) that communicate with each other using representational state transfer application programming interfaces (Restful APIs).

Furthermore, 5G Technical Specification (TS) 33.501, entitled “Technical Specification Group Services and System Aspects; Security Architecture and Procedures for the 5G System,” the disclosure of which is incorporated by reference herein in its entirety, further describes security management details associated with a 5G network.

Security management is an important consideration in any communication system. However, due to continuing attempts to improve the architectures and protocols associated with a 5G network in order to increase network efficiency and/or subscriber convenience, security management issues associated with configuration of a protection scheme when the UE moves between communication networks can present a significant challenge.

### SUMMARY

Illustrative embodiments provide protection scheme configuration techniques in a communication network.

For example, in one illustrative embodiment from a user equipment perspective, a method comprises: receiving, at the user equipment from a network entity of a communication system, protection scheme configuration data in accordance with an update procedure between the user equipment and the communication network; and generating, at the user equipment, a unique identifier for the user equipment based on at least of a portion of the received protection scheme configuration data.

For example, in one illustrative embodiment from a network entity perspective, a method comprises: at least one of receiving and generating, at a network entity of a communication network, protection scheme configuration data for user equipment connected to the communication network; and sending, to the user equipment, the protection scheme configuration data in accordance with an update procedure between the user equipment and the communication network to enable the user equipment to generate a unique identifier for the user equipment based on at least of a portion of the received protection scheme configuration data.

Advantageously, illustrative embodiments provide for a home communication network of given user equipment to send protection scheme configuration data to the given user equipment using a user equipment parameter update procedure, or a steering of roaming procedure in a visited communication network scenario.

Further illustrative embodiments are provided in the form of a non-transitory computer-readable storage medium having embodied therein executable program code that when executed by a processor causes the processor to perform the above steps. Still further illustrative embodiments comprise apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 illustrates a communication system with which one or more illustrative embodiments may be implemented.

FIG. 2 illustrates user equipment and network entities with which one or more illustrative embodiments may be implemented.

FIG. 3 illustrates an example format of a subscription concealed identifier for user equipment according to one or more illustrative embodiments.

FIG. 4 illustrates allowed protection schemes and corresponding communication network mapping tables according to one or more illustrative embodiments.

FIG. 5 illustrates a first procedure for configuration of a protection scheme according to one or more illustrative embodiments.

FIG. 6 illustrates a second procedure for configuration of a protection scheme according to one or more illustrative embodiments.

### DETAILED DESCRIPTION

Embodiments will be illustrated herein in conjunction with example communication systems and associated techniques for security management in communication systems. It should be understood, however, that the scope of the claims is not limited to particular types of communication systems and/or processes disclosed. Embodiments can be implemented in a wide variety of other types of communication systems, using alternative processes and operations. For example, although illustrated in the context of wireless cellular systems utilizing 3GPP system elements such as a 3GPP next generation system (5G), the disclosed embodiments can be adapted in a straightforward manner to a variety of other types of communication systems.

In accordance with illustrative embodiments implemented in a 5G communication system environment, one or more 3GPP technical specifications (TS) and technical reports (TR) may provide further explanation of network elements/functions and/or operations that may interact with parts of the inventive solutions, e.g., the above-referenced 3GPP TS 23.501 and 3GPP TS 33.501. Other 3GPP TS/TR documents may provide other details that one of ordinary skill in the art will realize, for example, 3GPP TS 31.115, entitled “Technical Specification Group Core Network and Terminals; Secured Packet Structure for (Universal) Subscriber Identity Module (U) SIM Toolkit Applications,” the disclosure of which is incorporated by reference herein in its entirety. However, while well-suited for 5G-related 3GPP standards, embodiments are not necessarily intended to be limited to any particular standards.

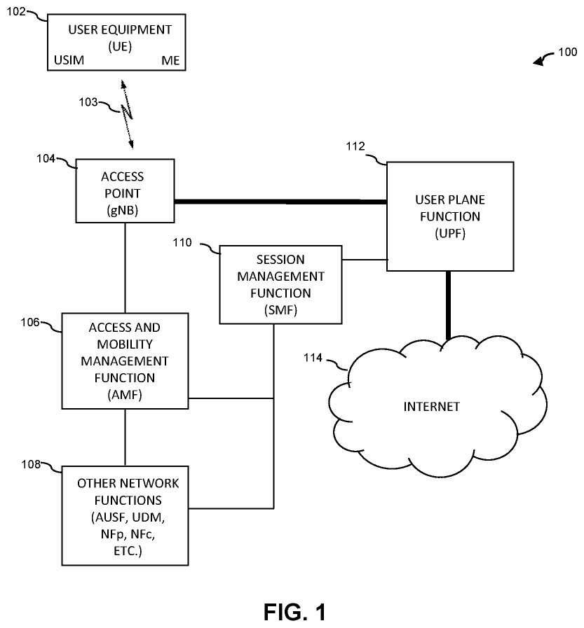

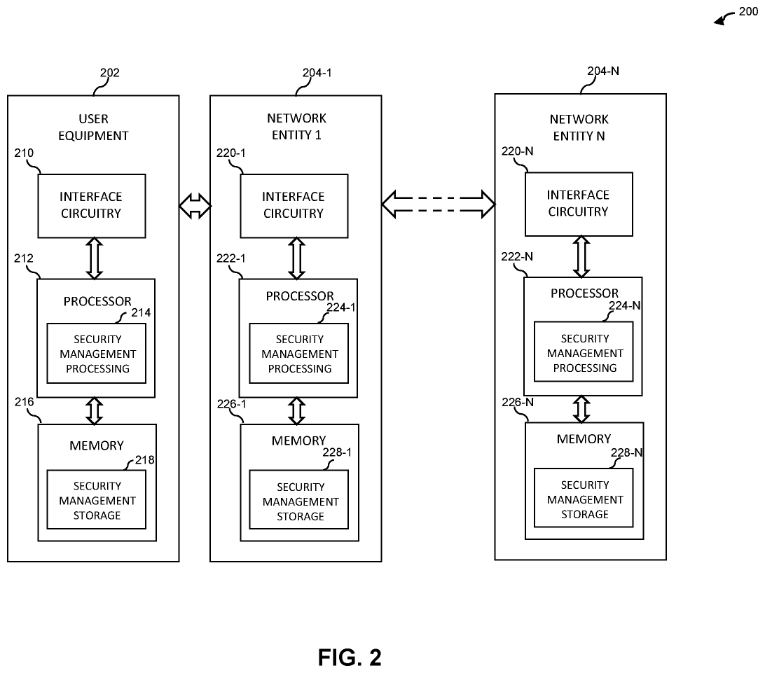

Prior to describing illustrative embodiments, a general description of certain main components of a 5G network will be described below in the context of FIGS. 1 and 2.

FIG. 1 shows a communication system 100 within which illustrative embodiments are implemented. It is to be understood that the elements shown in communication system 100 are intended to represent main functions provided within the system, e.g., UE access functions, mobility management functions, authentication functions, serving gateway functions, etc. As such, the blocks shown in FIG. 1 reference specific elements in 5G networks that provide these main functions. However, other network elements may be used to implement some or all of the main functions represented. Also, it is to be understood that not all functions of a 5G network are depicted in FIG. 1. Rather, at least some functions that facilitate an explanation of illustrative embodiments are represented. Subsequent figures may depict some additional elements/functions (i.e., network entities).

Accordingly, as shown, communication system 100 comprises user equipment (UE) 102 that communicates via an air interface 103 with an access point (gNB) 104. It is to be understood that UE 102 may use one or more other types of access points (e.g., access functions, networks, etc.) to communicate with the 5G core other than a gNB. By way of example only, the access point 104 may be any 5G access network, an untrusted non-3GPP access network that uses an N3IWF (Non-3GPP Interworking Function), a trusted non-3GPP network that uses a TNGF (Trusted Non-3GPP Gateway Function) or wireline access that uses a W-AGF (Wireline Access Gateway Function) or may correspond to a legacy access point (e.g., eNB).

The UE 102 may be a mobile station, and such a mobile station may comprise, by way of example, a mobile telephone, a computer, an IoT device, or any other type of communication device. The term “user equipment” as used herein is therefore intended to be construed broadly, so as to encompass a variety of different types of mobile stations, subscriber stations or, more generally, communication devices, including examples such as a combination of a data card inserted in a laptop or other equipment such as a smart phone. Such communication devices are also intended to encompass devices commonly referred to as access terminals.

In one embodiment, UE 102 is comprised of a Universal Integrated Circuit Card (UICC) part and a Mobile Equipment (ME as illustrated in FIG. 1) part. The UICC is the user-dependent part of the UE and contains at least one Universal Subscriber Identity Module (USIM as illustrated in FIG. 1) and appropriate application software. The USIM securely stores a permanent subscription identifier and its related key, which are used to uniquely identify and authenticate subscribers to access networks. The ME is the user-independent part of the UE and contains terminal equipment (TE) functions and various mobile termination (MT) functions. The USIM may be more generally referred to herein as a “subscriber identity-dependent part” of the UE, while the ME may be more generally referred to herein as a “subscriber identity-independent part” of the UE.

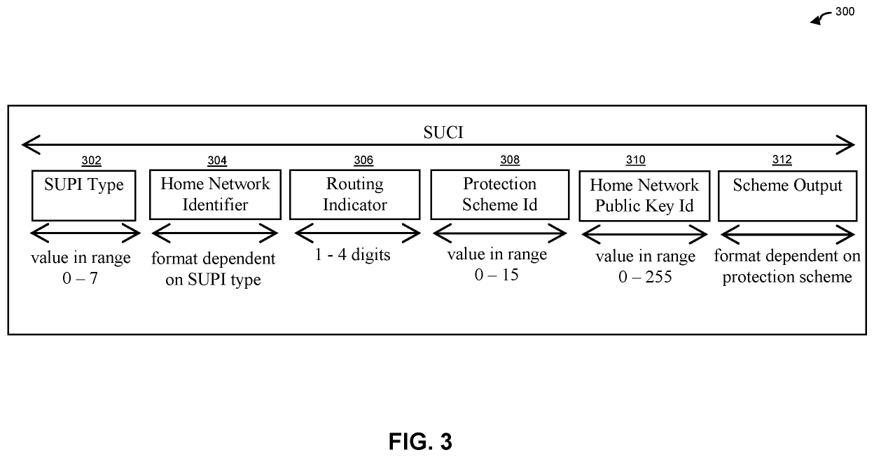

Note that, in one example, the permanent subscription identifier is an International Mobile Subscriber Identity (IMSI) unique to the UE. In one embodiment, the IMSI is a fixed 15-digit length and consists of a 3-digit Mobile Country Code (MCC), a 3-digit Mobile Network Code (MNC), and a 9-digit Mobile Station Identification Number (MSIN). In a 5G communication system, an IMSI is referred to as a Subscription Permanent Identifier (SUPI). In the case of an IMSI as a SUPI, the MSIN provides the subscriber identity. Thus, only the MSIN portion of the IMSI typically needs to be encrypted. The MNC and MCC portions of the IMSI provide routing information, used by the serving network to route to the correct home network. When the MSIN of a SUPI is encrypted, it is referred to as Subscription Concealed Identifier (SUCI). Another example of a SUPI uses a Network Access Identifier (NAI). NAI is typically used for IoT communication. Further details of an example format of a SUCI will be described below in the context of FIG. 3.

The access point 104 is illustratively part of an access network of the communication system 100. Such an access network may comprise, for example, a 5G System having a plurality of base stations.

Further, the access point 104 in this illustrative embodiment is operatively coupled to an Access and Mobility Management Function (AMF) 106. In a 5G network, the AMF supports, inter alia, mobility management (MM) and security anchor (SEAF) functions.

AMF 106 in this illustrative embodiment is operatively coupled to (e.g., uses the services of) other network functions 108. As shown, some of these other network functions 108 include, but are not limited to, an Authentication Server Function (AUSF), a Unified Data Management (UDM) function, and other network functions that can act as service producers (NFp) and/or service consumers (NFc). Note that any network function can be a service producer for one service and a service consumer for another service. Further, when the service being provided includes data, the data-providing NFp is referred to as a data producer, while the data-requesting NFc is referred to as a data consumer. A data producer may also be an NF that generates data by modifying or otherwise processing data produced by another NF.

Note that a UE, such as UE 102, is typically subscribed to what is referred to as a Home Public Land Mobile Network (HPLMN) in which some or all of the functions 106 and 108 reside. Alternatively the UE, such as UE 102, may receive services from a non-Public Network (NPN) where these functions may reside. The HPLMN is also referred to as the Home Environment (HE). If the UE is roaming (not in the HPLMN), it is typically connected with a Visited Public Land Mobile Network (VPLMN) also referred to as a visited network, while the network that is currently serving the UE is also referred to as a serving network. In the roaming case, some of the network functions 106 and 108 can reside in the VPLMN, in which case, functions in the VPLMN communicate with functions in the HPLMN as needed. However, in a non-roaming scenario, mobility management functions 106 and the other network functions 108 reside in the same communication network, i.e. HPLMN. Embodiments described herein are not necessarily limited by which functions reside in which PLMN (i.e., HPLMN or VPLMN). Furthermore, it is to be understood that embodiments described herein are not necessarily limited to PLMNs, but rather can be implemented in Standalone Non-Public Networks (SNPNs). An SNPN is a private communication network that is managed by an NPN operator.

The access point 104 is also operatively coupled (via one or more of functions 106 and/or 108) to a Session Management Function (SMF) 110, which is operatively coupled to a User Plane Function (UPF) 112. UPF 112 is operatively coupled to a Packet Data Network, e.g., Internet 114. Note that the thicker solid lines in this figure denote a user plane (UP) of the communication network, as compared to the thinner solid lines that denote a control plane (CP) of the communication network. It is to be appreciated that network 114 in FIG. 1 may additionally or alternatively represent other network infrastructures including, but not limited to, cloud computing infrastructure and/or edge computing infrastructure. Further typical operations and functions of such network elements are not described here since they are not the focus of the illustrative embodiments and may be found in appropriate 3GPP 5G documentation. Note that functions shown in 106, 108, 110 and 112 are examples of network functions (NFs).

It is to be appreciated that this particular arrangement of system elements is an example only, and other types and arrangements of additional or alternative elements can be used to implement a communication system in other embodiments. For example, in other embodiments, the system 100 may comprise other elements/functions not expressly shown herein.

Accordingly, the FIG. 1 arrangement is just one example configuration of a wireless cellular system, and numerous alternative configurations of system elements may be used. For example, although only single elements/functions are shown in the FIG. 1 embodiment, this is for simplicity and clarity of description only. A given alternative embodiment may of course include larger numbers of such system elements, as well as additional or alternative elements of a type commonly associated with conventional system implementations.

It is also to be noted that while FIG. 1 illustrates system elements as singular functional blocks, the various subnetworks that make up the 5G network are partitioned into so-called network slices. Network slices (network partitions) are logical networks that provide specific network capabilities and network characteristics that can support a corresponding service type, optionally using network function virtualization (NFV) on a common physical infrastructure. With NFV, network slices are instantiated as needed for a given service, e.g., eMBB service, massive IoT service, and mission-critical IoT service. A network slice or function is thus instantiated when an instance of that network slice or function is created. In some embodiments, this involves installing or otherwise running the network slice or function on one or more host devices of the underlying physical infrastructure. UE 102 is configured to access one or more of these services via gNB 104.

FIG. 2 is a block diagram illustrating computing architectures for various participants in methodologies according to illustrative embodiments. More particularly, system 200 is shown comprising user equipment (UE) 202 and a plurality of network entities 204-1, . . . , 204-N. For example, in illustrative embodiments and with reference back to FIG. 1, UE 202 can represent UE 102, while network entities 204-1, . . . , 204-N can represent functions 106 and 108. It is to be appreciated that the UE 202 and network entities 204-1, . . . , 204-N are configured to interact to provide security management and other techniques described herein.

The user equipment 202 comprises a processor 212 coupled to a memory 216 and interface circuitry 210. The processor 212 of the user equipment 202 includes a security management processing module 214 that may be implemented at least in part in the form of software executed by the processor. The processing module 214 performs security management described in conjunction with subsequent figures and otherwise herein. The memory 216 of the user equipment 202 includes a security management storage module 218 that stores data generated or otherwise used during security management operations.

Each of the network entities (individually or collectively referred to herein as 204) comprises a processor 222 (222-1, . . . , 222-N) coupled to a memory 226 (226-1, . . . , 226-N) and interface circuitry 220 (220-1, . . . , 220-N). Each processor 222 of each network entity 204 includes a security management processing module 224 (224-1, . . . , 224-N) that may be implemented at least in part in the form of software executed by the processor 222. The processing module 224 performs security management operations described in conjunction with subsequent figures and otherwise herein. Each memory 226 of each network entity 204 includes a security management storage module 228 (228-1, . . . , 228-N) that stores data generated or otherwise used during security management operations.

The processors 212 and 222 may comprise, for example, microprocessors such as central processing units (CPUs), application-specific integrated circuits (ASICs), digital signal processors (DSPs) or other types of processing devices, as well as portions or combinations of such elements.

The memories 216 and 226 may be used to store one or more software programs that are executed by the respective processors 212 and 222 to implement at least a portion of the functionality described herein. For example, security management operations and other functionality as described in conjunction with subsequent figures and otherwise herein may be implemented in a straightforward manner using software code executed by processors 212 and 222.

A given one of the memories 216 and 226 may therefore be viewed as an example of what is more generally referred to herein as a computer program product or still more generally as a processor-readable storage medium that has executable program code embodied therein. Other examples of processor-readable storage media may include disks or other types of magnetic or optical media, in any combination. Illustrative embodiments can include articles of manufacture comprising such computer program products or other processor-readable storage media.

Further, the memories 216 and 226 may more particularly comprise, for example, electronic random-access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The interface circuitries 210 and 220 illustratively comprise transceivers or other communication hardware or firmware that allows the associated system elements to communicate with one another in the manner described herein.

It is apparent from FIG. 2 that user equipment 202 and plurality of network entities 204 are configured for communication with each other as security management participants via their respective interface circuitries 210 and 220. This communication involves each participant sending data to and/or receiving data from one or more of the other participants. The term “data” as used herein is intended to be construed broadly, so as to encompass any type of information that may be sent between participants including, but not limited to, identity data, key pairs, key indicators, security management messages, registration request/response messages and data, request/response messages, authentication request/response messages and data, metadata, control data, audio, video, multimedia, consent data, other messages, etc.

It is to be appreciated that the particular arrangement of components shown in FIG. 2 is an example only, and numerous alternative configurations may be used in other embodiments. For example, any given network element/function can be configured to incorporate additional or alternative components and to support other communication protocols.

Other system elements such as gNB 104, SMF 110, and UPF 112 may each be configured to include components such as a processor, memory and network interface. These elements need not be implemented on separate stand-alone processing platforms, but could instead, for example, represent different functional portions of a single common processing platform.

More generally, FIG. 2 can be considered to represent processing devices configured to provide respective security management functionalities and operatively coupled to one another in a communication system.

As mentioned above, a SUCI is established for each UE 102. The SUCI serves as a privacy preserving identifier containing a concealed SUPI as defined in the above-referenced 3GPP TS 33.501 and depicted in format 300 of FIG. 3. As shown, SUCI format 300 comprises a SUPI type 302, a home network identifier 304, a routing indicator 306, a protection scheme identifier (ID) 308, a home network public key ID 310, and a scheme output 312. While some of the values in format 300 have fixed ranges, some values depend on other values as shown.

More particularly, as shown, protection scheme ID 308 comprises a value in the range of 0 to 15. Protection scheme ID 308 represents the null scheme, a non-null scheme specified in Annex C of the above-referenced 3GPP TS 33.501, or a protection scheme specified by the HPLMN. The null scheme is used if the SUPI type is a global line identifier (GLI) or a global cable identifier (GCI), and is not privacy preserving.

The UE 102 generates a SUCI using the null-scheme only in the following cases:
(i) when the UE 102 is establishing an unauthenticated emergency session and it does not have a 5G-GUTI to the chosen PLMN;
(ii) when the home network has configured null-scheme to be used; or
(iii) when the home network has not provisioned the public key needed to generate a SUCI.

If it is the network operator's decision that the ME of the UE 102 should calculate the SUCI, the home network operator provisions in the USIM of the UE 102 an ordered priority list of the protection scheme IDs that the operator allows. The priority list of protection scheme identifiers in the USIM only contains protection scheme IDs specified in the above-referenced Annex C of 3GPP TS 33.501, and the list may contain one or more protection schemes IDs. The ME reads the SUCI calculation information from the USIM, including the SUPI, the SUPI type, the routing indicator, the home network public key ID, the home network public key and the list of protection scheme IDs. The ME selects the protection scheme from its supported schemes that has the highest priority in the list obtained from the USIM. The ME calculates the SUCI using the null-scheme if the home network public key or the priority list are not provisioned in the USIM. Note that this feature is provided since additional protection schemes could be specified in the future for a release newer than the ME release. In this case, the protection scheme selected by older MEs may not be the protection scheme with the highest priority in the list of the USIM. The network operator should use proprietary identifiers for protection schemes if the network operator chooses that the calculation of the SUCI should be done in the USIM.

Currently, the scheme for SUCI (i.e., null, profile A, and profile B) is configured in the UICC of the UE 102 with a priority list. For all VPLMNs, the UE/UICC uses the same configurations as the HPLMN (i.e., same priority list). For some of the countries or VPLMNs, the null scheme or operator-configured, customized (proprietary) scheme is not allowed. Secondly, the use of the null scheme carries the threat of exposing the identity, so it should not be used in certain networks.

For example, if the null scheme is enabled at the UE 102 (e.g., due to a lawful interception or LI requirement) in the HPLMN, and then the UE 102 crosses a border into another country or geographic region and accesses a VPLMN, then the same null scheme will be used at the VPLMN. This increases the threat of UE identity exposure over the air. As LI requirements are country specific, using the null scheme at the VPLMN is a significant security risk to the UE 102.

Currently, the protection scheme can be changed via an over-the-air (OTA) procedure, which usually works in the HPLMN. However, a USIM setting message sent to the VPLMN may be discarded due to a security/firewall or it may also cause additional charging, so it is avoided or not supported in the VPLMN.

Currently, there is no mechanism available to update the protection scheme dynamically via 5GC in VPLMN. Furthermore, protection schemes stored in the USIM of the UE 102 are not PLMN-specific. Therefore, the network operator has no control over which protection scheme should be used in which PLMN.

Illustrative embodiments overcome the above and other drawbacks by providing technical solutions which provide for improved protection scheme configuration in communication networks. For example, in accordance with one or more illustrative embodiments, the HPLMN sends the allowed protection scheme and a PLMN mapping table to the UICC of the UE 102 using a UE Parameter Update (UPU) procedure or a Steering of Roaming (SoR) procedure in VPLMN scenarios. Further, in one or more illustrative embodiments, the HPLMN updates the home network public key list and protection scheme configured in the UICC. Still further, in one or more illustrative embodiments, the UE 102 indicates its capability via a container transparent to the VPLMN; and via a 5G mobility management (5GMM) capability information element (IE) which is not transparent to the VPLMN (the VPLMN forwards the capability indication to the HPLMN).

It is to be appreciated that although the description below is based on the PLMN case, configuration of a protection scheme according to illustrative embodiments can be extended to the SNPN case without loss of generality.

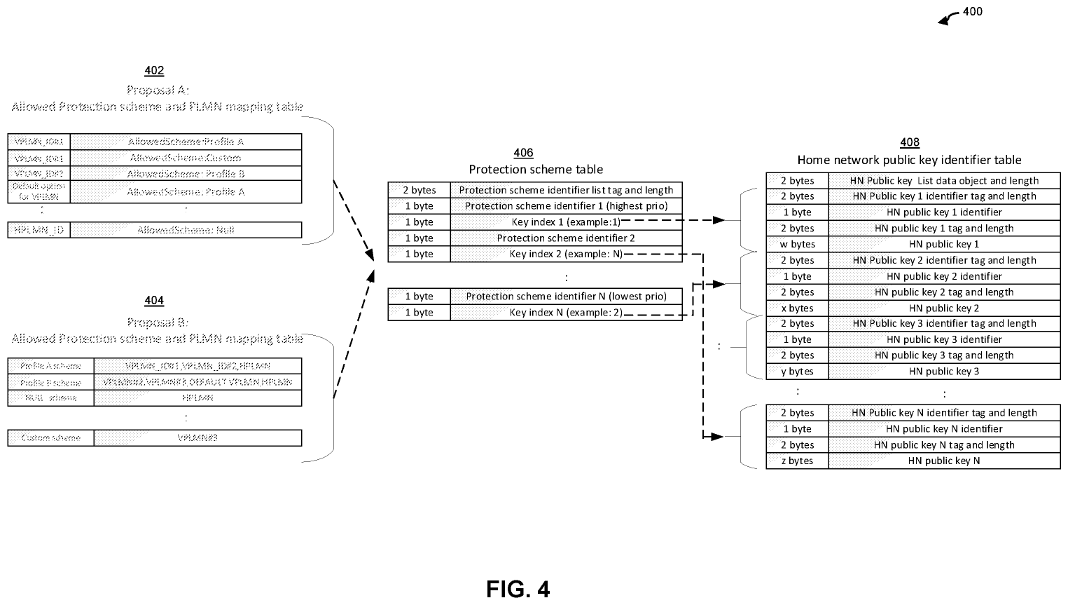

Further details on the IE sent to the UE 102 will now be described in the context of FIG. 4 which depicts an example 400 of allowed protection schemes and a PLMN mapping table. The HPLMN may send protection schemes associated with PLMN IDs.

With Proposal A format 402, the UICC of the UE 102 has each PLMN listed with corresponding allowed schemes.

With Proposal B format 404, the UICC of the UE 102 has each protection scheme with the corresponding allowed list of VPLMNs and HPLMN.

The default option of the VPLMN is to confirm that if a VPLMN is not listed in this configuration, then the UICC can use the corresponding allowed scheme for that particular VPLMN.

In an allowed protection scheme only configuration, the HPLMN can simply update a list of protection schemes to the UE 102, e.g., see protection scheme table 406.

Further, the HPLMN can update (add or remove) the home network public key configured in the UICC of the UE 102, e.g., see home network public key identifier table 408.

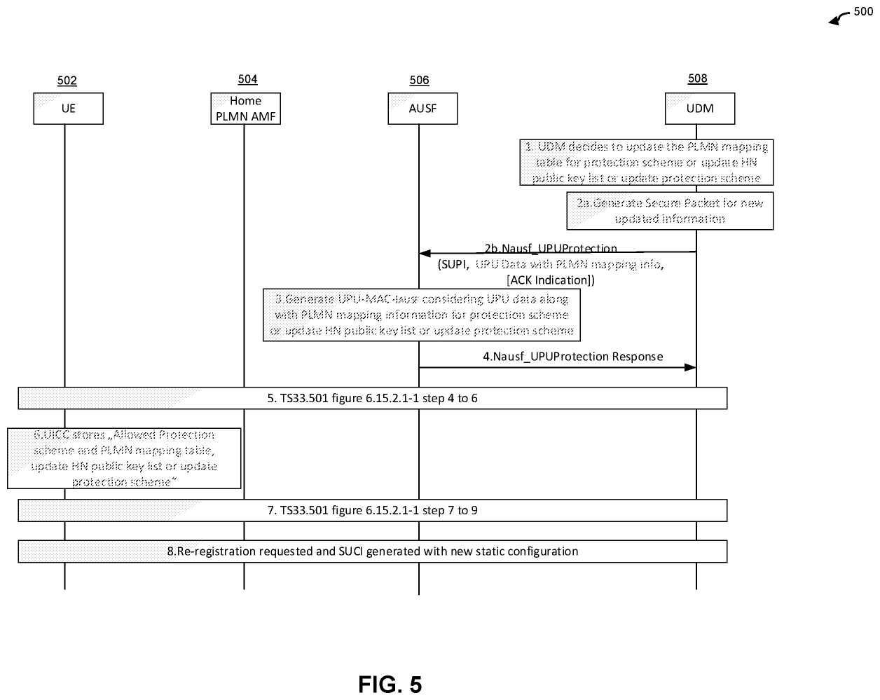

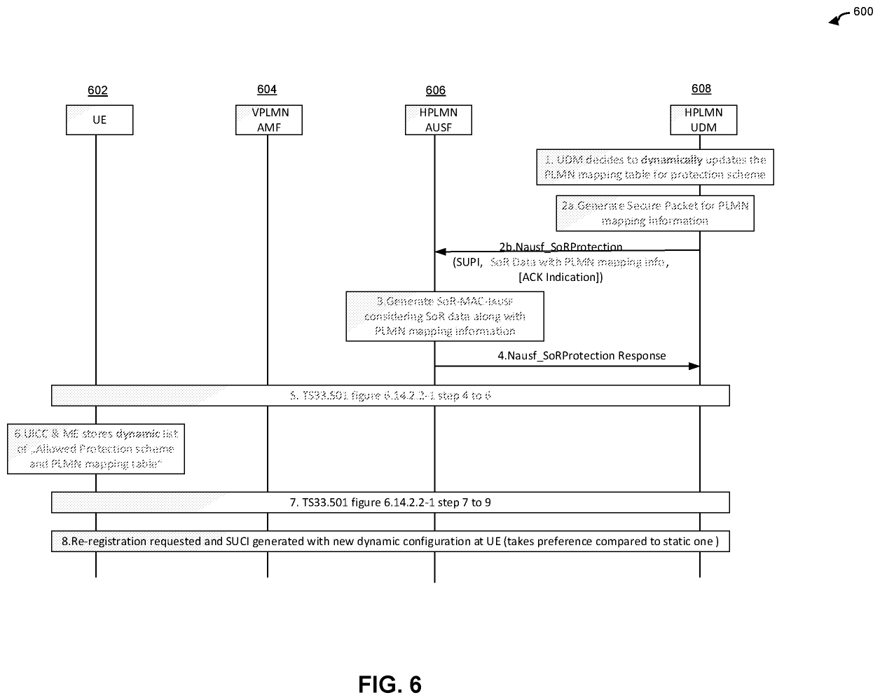

Illustrative embodiments provide a procedure for sending a protection scheme information element (e.g., as described above in the context of FIG. 4) to the UE 102. FIG. 5 illustrates a UPU procedure for sending the protection scheme information, and FIG. 6 illustrates an SoR procedure for sending the protection scheme information.

In a UPU procedure update embodiment, a UDM updates the information described above in the context of FIG. 4 (illustratively referred to herein as “protection scheme configuration data”) via a UPU procedure. The UDM can perform this procedure based on an internal trigger such as, for example, the UE is roaming in a certain PLMN (i.e., registration request at the UDM) or based on a provisioning change request.

More particularly, FIG. 5 illustrates a procedure 500 for static protection scheme configuration using a UPU procedure according to an illustrative embodiment. As shown, procedure 500 involves a UE 502, an AMF 504, a AUSF 506, and a UDM 508.

In step 1, UDM 508 decides to update the PLMN protection scheme mapping table, update the home network public key, or update the protection scheme.

In step 2a, UDM 508 generates a secured packet with the new updated information (protection scheme configuration data) and includes the secured packet in UPU data. Alternatively, UDM 508 can prepare UPU data by directly including the updated information (protection scheme configuration data).

In step 2b, UDM 508 sends the UPU data as part of a Nausf UPU Protection message described in the above-referenced 3GPP TS 31.115.

In step 3, AUSF 506 generates the UPU-MAC-IAUSF with UPU data containing the protection scheme configuration data.

In step 4, AUSF 506 sends the generated UPU-MAC-IAUSF back along with counter information to UDM 508 as part of a Nausf UPU Protection response.

In step 5, UDM 508 sends the UPU data to AMF 504, and AMF 504 sends the same to UE 502. Step 5 can be performed in accordance with TS 33.501 FIG. 6.15.2.1-1 as follows (note that steps (i), (ii), and (iii) below correspond to steps 4, 5, and 6 of TS 33.501 FIG. 6.15.2.1-1):
i) UDM 508 invokes Nudm_SDM_Notification service operation, which includes the UPU transparent container if AMF 504 supports the UPU transparent container, or includes individual IEs comprising the UE Parameters Update Data, UPU-MAC-I_{AUSF}, CounterUPU within the Access and Mobility Subscription data. If UDM 508 requests an acknowledgement, it temporarily stores the expected UPU-XMAC-I_{UE}.
ii) Upon receiving the Nudm_SDM_Notification message, AMF 504 sends a DL NAS Transport message to the served UE 502. AMF 504 includes in the DL NAS Transport message the transparent container if received from UDM 508 in step (i) above. Otherwise, if UDM 508 provided individual IEs in step (i) above, then the AMF shall construct a UPU transparent container.
iii) On receiving the DL NAS Transport message, UE 502 calculates the UPU-MAC-I_{AUSF} in the same way as AUSF 506 on the received UE Parameters Update Data and the CounterUPU and verifies whether it matches the UPU-MAC-I_{AUSF} value received within the UPU transparent container in the DL NAS Transport message. If the verification of UPU-MAC-I_{AUSF} is successful and the UPU Data contains any parameters that are protected by secured packet, the ME forwards the secured packet to the USIM. If the verification of UPU-MAC-I_{AUSF} is successful and the UPU Data contains any parameters that are not protected by secured packet, the ME updates its stored parameters with the received parameters in UDM Updata Data.

As the information is for the UICC of UE 502, the ME of UE 502 forward it to the UICC, and in step 6, the UICC stores the information. Alternatively, the final consumer for the information can be the ME of UE 502, in which case the ME of UE 502 stores the information.

In step 7, the following steps occur in accordance with TS 33.501 FIG. 6.15.2.1-1 as follows (note that steps (iv), (v), and (vi) below correspond to steps 7, 8, and 9 of TS 33.501 FIG. 6.15.2.1-1):
iv) If UDM 508 has requested an acknowledgement from UE 502 and UE 502 has successfully verified and updated the UE Parameters Update Data provided by UDM 508, then UE 502 sends the UL NAS Transport message to AMF 504. UE 502 generates the UPU-MAC-I_{UE} and includes the generated UPU-MAC-I_{UE} in a transparent container in the UL NAS Transport message.
v) If a transparent container with the UPU-MAC-I_{UE} was received in the UL NAS Transport message, the AMF 504 sends a Nudm_SDM_Info request message with the transparent container to UDM 508.
vi) If UDM 508 indicated that UE 502 is to acknowledge the successful security check of the received UE Parameters Update Data, then UDM 508 compares the received UPU-MAC-I_{UE} with the expected UPU-XMAC-I_{UE} that UDM 508 stored temporarily in step (i) above.

In step 8, if the HPLMN has requested re-registration, due to the new configuration update, UE 502 triggers a registration request and SUCI generation with the updated information.

Turning now to an SoR procedure update embodiment, the UDM updates the protection scheme configuration data via a SoR procedure. The UDM can perform this procedure based on an internal trigger such as, for example, the UE is roaming in a certain PLMN (i.e., registration request at the UDM) or based on a provisioning change request.

More particularly, FIG. 6 illustrates a procedure 600 for dynamic protection scheme configuration using a SoR procedure according to an illustrative embodiment. As shown, procedure 600 involves a UE 602, a VPLMN AMF 604, an HPLMN AUSF 606, and an HPLMN UDM 608.

In step 1, HPLMN UDM 608 decides to dynamically update the PLMN protection scheme mapping table, update the home network public key, or update the protection scheme.

In step 2a, HPLMN UDM 608 generates a secured packet with the new updated information (protection scheme configuration data).

In step 2b, HPLMN UDM 608 sends the secured packet as part of a Nausf SoR Protection message described in the above-referenced 3GPP TS 31.115.

In step 3, HPLMN AUSF 606 generates the SoR-MAC-I_{AUSF} with SoR data containing the protection scheme configuration data.

In step 4, HPLMN AUSF 606 sends the generated SoR-MAC-I_{AUSF} back along with counter information to HPLMN UDM 608 as part of a Nausf SoR Protection response.

In step 5, HPLMN UDM 608 sends the SoR data to VPLMN AMF 604, and VPLMN AMF 604 sends the same to UE 602. Step 5 can be performed in accordance with TS 33.501 FIG. 6.14.2.2-1 as follows (note that steps (i), (ii), and (iii) below correspond to steps 4, 5, and 6 of TS 33.501 FIG. 6.14.2.2-1):
i) HPLMN UDM 608 invokes Nudm_SDM_Notification service operation, which includes the SoR transparent container if VPLMN AMF 604 supports SoR transparent container, or contains individual IEs including an optional list of preferred PLMN/access technology combinations or secured packet, the ACK Indication, SoR-MAC-I_{AUSF}, and Counters_{SoR} within the Access and Mobility Subscription data. If HPLMN UDM 608 requests an acknowledgement, it temporarily stores the expected SOR-XMAC-I_{UE}.
ii) Upon receiving the Nudm_SDM_Notification message, if the SoR transparent container is included in the message, the VPLMN AMF 604 sends a DL NAS Transport message to the served UE 602 including the received SoR transparent container; otherwise, VPLMN AMF 604 constructs the SoR transparent container (including the SoR header) based on the ACK Indication, the Steering List, SoR-MAC-I_{AUSF} and Counter_{SoR} received from HPLMN UDM 608, and sends the constructed SoR transparent container included to the served UE 602 in a DL NAS Transport message.
iii) On receiving the DL NAS Transport message, UE 602 calculates the SoR-MAC-I_{AUSF} in the same way as HPLMN AUSF 606 on the received SoR transparent container, including the Counter_{SoR} and the SoR header and verifies whether it matches the SoR-MAC-I_{AUSF} value received in the DL NAS Transport message.

As the dynamic configuration is for the UICC and the ME of UE 602, the ME forwards the protection scheme configuration data to the UICC. In step 6, the UICC and the ME store the protection scheme configuration data. UICC can also share configurations to the ME.

In step 7, the following steps occur in accordance with TS 33.501 FIG. 6.14.2.2-1 as follows (note that steps (iv), (v), and (vi) below correspond to steps 7, 8, and 9 of TS 33.501 FIG. 6.14.2.2-1):
iv) If the HPLMN UDM 608 has requested an acknowledgement from UE 602 and UE 602 verified that the Steering Information has been provided by the HPLMN, then UE 602 sends the UL NAS Transport message to the VPLMN AMF 604. UE 602 generates the SoR-MAC-I_{UE} and includes the generated SoR-MAC-I_{UE} in a SoR transparent container in the UL NAS Transport message.
v) VPLMN AMF 604 sends a Nudm_SDM_Info request message to HPLMN UDM 608. If a SoR transparent container with the SoR-MAC-I_{UE} was received in the UL NAS Transport message, VPLMN AMF 604 includes the received SoR transparent container in the Nudm_SDM_Info request message if the VPLMN AMF 604 supports SoR transparent container; otherwise, VPLMN AMF 604 includes the SoR-MAC-I_{UE} in the Nudm_SDM_Info request message.
vi) If the HPLMN indicated that UE 602 is to acknowledge the successful security check of the received Steering of Roaming Information, then HPLMN UDM 608 compares the received SoR-MAC-I_{UE} with the expected SoR-XMAC-I_{UE} that HPLMN UDM 608 stored temporarily in step (i) above.

In step 8, if the HPLMN has requested re-registration, due to the new dynamic configuration update, UE 602 triggers a registration request and SUCI generation with the updated information. A dynamic configuration received takes precedence compared to a static configuration. Once the ME leaves this PLMN and camps on a different PLMN, this dynamic configuration is deleted.

It is to be appreciated that the HPLMN sends the protection scheme configuration data only to a UE that supports receiving the information. In order to achieve this capability, in accordance with an illustrative embodiment, a UE capable of receiving the information indicates its capability to the HPLMN. The UE indicates its capability using at least one of the following methods: (i) via a container transparent to the VPLMN; and (ii) via a 5GMM capability IE which is not transparent to the VPLMN (the VPLMN forwards the capability indication to the HPLMN). Alternatively, the UE's capability to update the information can be configured in the HPLMN.

As used herein, it is to be understood that the term “communication network” in some embodiments can comprise two or more separate communication networks. Further, the particular processing operations and other system functionality described in conjunction with the diagrams described herein are presented by way of illustrative example only, and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the various embodiments described herein are presented by way of illustrative example only and should not be construed as limiting the scope of the claims. For example, alternative embodiments can utilize different communication system configurations, user equipment configurations, base station configurations, provisioning and usage processes, messaging protocols and message formats than those described above in the context of the illustrative embodiments. These and numerous other alternative embodiments within the scope of the appended claims will be readily apparent to those skilled in the art.

1. An apparatus comprising:
at least one processor;
at least one memory including computer program code;
the at least one memory and the computer program code being configured to, with the at least one processor, cause the apparatus at least to:
receive, from a network entity of a communication network, protection scheme configuration data in accordance with an update procedure between the apparatus and the communication network; and
generate a unique identifier for the apparatus based on at least of a portion of the received protection scheme configuration data.

2. The apparatus of claim 1, wherein the update procedure comprises a user equipment parameter update procedure.

3. The apparatus of claim 1, wherein the update procedure comprises a steering of roaming procedure.

4. The apparatus of claim 1, wherein the at least one memory and the computer program code is further configured to, with the at least one processor, cause the apparatus to at least one of: (i) store the protection scheme configuration data; and (ii) update previously stored protection scheme configuration data with the protection scheme configuration data.

5. The apparatus of claim 1, wherein the protection scheme configuration data comprises one or more identifiers corresponding to one or more of allowable protection schemes.

6. The apparatus of claim 1, wherein the protection scheme configuration data comprises one or more identifiers corresponding to one or more of allowable communication networks.

7. The apparatus of claim 1, wherein the protection scheme configuration data comprises one or more identifiers corresponding to one or more of allowable communication network public keys.

8. The apparatus of claim 1, wherein the at least one memory and the computer program code is further configured to, with the at least one processor, cause the apparatus to notify the communication network of configured protection scheme capabilities.

9. The apparatus of claim 1, wherein the communication network is one of a home communication network and a visited communication network.

10. The apparatus of claim 1, wherein the communication network is one of a public communication network and a private communication network.

11. The apparatus of claim 1, wherein the apparatus is part of user equipment connected to the communication network.

12. A method comprising:
receiving, at user equipment from a network entity of a communication network, protection scheme configuration data in accordance with an update procedure between the user equipment and the communication network; and
generating, at the user equipment, a unique identifier for the user equipment based on at least of a portion of the received protection scheme configuration data.

13-14. (canceled)

15. An apparatus comprising:
at least one processor;
at least one memory including computer program code;
the at least one memory and the computer program code being configured to, with the at least one processor, cause the apparatus at least to:
at least one of receive or generate protection scheme configuration data for user equipment connected to a communication network; and
send, to the user equipment, the protection scheme configuration data in accordance with an update procedure between the user equipment and the communication network to enable the user equipment to generate a unique identifier for the user equipment based on at least of a portion of the received protection scheme configuration data.

16. The apparatus of claim 15, wherein the update procedure comprises a user equipment parameter update procedure.

17. The apparatus of claim 15, wherein the update procedure comprises a steering of roaming procedure.

18. The apparatus of claim 15, wherein the protection scheme configuration data comprises one or more identifiers corresponding to one or more of allowable protection schemes.

19. The apparatus of claim 15, wherein the protection scheme configuration data comprises one or more identifiers corresponding to one or more of allowable communication networks.

20-23. (canceled)

24. The apparatus of claim 15, wherein the apparatus is part of a unified data management function of the communication network.

25. The apparatus of claim 15, wherein the apparatus is part of an authentication server function of the communication network.

26. The apparatus of claim 15, wherein the apparatus is part of an access and mobility management function of the communication network.

27-31. (canceled)
